(19) United States
(12) Patent Application Publication
(10) Pub. No.: US 2022/0340170 A1
(43) Pub. Date: Oct. 27, 2022

(54) DRIVING RISK IDENTIFICATION METHOD, STORAGE MEDIUM AND ELECTRONIC DEVICE

(71) Applicant: Beijing Sankuai Online Technology Co., Ltd., Beijing (CN)

(72) Inventors: Huaxia XIA, Beijing (CN); Qi WANG, Beijing (CN); Mingyu FAN, Beijing (CN); Dongchun REN, Beijing (CN); Kebin YUAN, Beijing (CN); Shuguang DING, Beijing (CN)

(21) Appl. No.: 17/674,737

(22) Filed: Feb. 17, 2022

(30) Foreign Application Priority Data
Apr. 25, 2021 (CN) 202110445196.5

(51) Int. Cl. B60W 60/00; B60W 40/02; B60W 40/105; B60W 50/00; G06V 20/58; G06N 3/04; G06N 3/08

(52) U.S. Cl. CPC B60W 60/0015; B60W 40/02; B60W 40/105; B60W 50/00; G06V 20/58; G06N 3/0454; G06N 3/08; B60W 2050/0043; B60W 2554/80

(57) ABSTRACT

Embodiments provide extracting information respectively corresponding to predetermined dimensions from environment information corresponding to an unmanned driving environment. In some embodiments, the information respectively corresponding to the dimensions is input into an identification model to obtain a driving feature. Then a risk value representing a driving risk degree of an unmanned device is determined, and a maximum variation of the information corresponding to at least one dimension is determined when a variation of the driving feature is less than a predetermined threshold. A maximum variation of the information corresponding to each dimension is used as a risk contribution feature. A variation representative value of the information corresponding to each dimension is determined from the risk contribution feature. According to the variation representative values of the dimensions, a driving risk factor corresponding to the risk value is determined based on the driving feature.

### CROSS-REFERENCE TO RELATED APPLICATIONS

The present disclosure claims priority to Chinese Patent Application No. 202110445196.5 filed on Apr. 25, 2021, which is incorporated by reference herein in its entirety.

### TECHNICAL FIELD

The present disclosure relates to the field of unmanned driving technologies, and in particular to a driving risk identification method, a storage medium and an electronic device.

### BACKGROUND

During the driving of a vehicle, driving risk identification may be performed for the vehicle. The driving risk identification may include identifying whether there is a risk during the driving of the vehicle and identifying risk factors when there is a risk during the driving of the vehicle. The risk factors, that is, the causes of the driving risk, may include factors such as the driving speed and the distance from other vehicles.

For an unmanned driving device, driving risks may be identified in various ways. The relatively common way is a rule-based manner, that is, obtaining driving data of the unmanned driving device and vehicles in the surrounding environment, identifying, according to set rules, for example, whether the speed difference and distance between the unmanned driving device and another vehicle are within safe ranges, whether there is a risk during the driving of the unmanned driving device, and determining risk factors when it is identified that there is a driving risk. Because the actual vehicle driving environment is very complex, the method of identifying driving risks based on predetermined rules cannot meet the requirements of all driving scenarios.

Another common way is a model-based manner, that is, the unmanned driving device may input the driving data of the unmanned driving device and vehicles in the surrounding environment into a pre-trained model to obtain the driving risk level determined by the model. Although this method can be applied to various driving scenarios, risk factors corresponding to the driving risk level cannot be determined in this method.

### SUMMARY

Embodiments provide a driving risk identification method and apparatus, to partly resolve the problems in the related art.

Embodiments provide a driving risk identification method, the method including: extracting, according to dimensions which are predetermined, information respectively corresponding to the dimensions from environment information corresponding to an unmanned driving environment; inputting the obtained information into a feature identification submodel of an identification model to obtain a driving feature outputted by the feature identification submodel, where when the driving feature is inputted into a risk determining submodel of the identification model, the risk determining submodel outputs a risk value representing a driving risk degree of an unmanned device; determining a maximum variation of the information corresponding to at least one of the dimensions in response to a variation of the driving feature being less than a predetermined threshold, and using a maximum variation of the information corresponding to each of the at least one of the dimensions as a risk contribution feature; for each of the at least one of the dimensions, determining, from the risk contribution feature, a variation representative value of the information corresponding to the dimension; and according to the variation representative value of the information corresponding to each of the at least one of the dimensions, determining, from the information corresponding to each of the at least one of the dimensions, a driving risk factor corresponding to the risk value determined based on the driving feature.

Embodiments provide a driving risk identification apparatus, the apparatus including:

an obtaining module, configured to extract, according to predetermined dimensions, information respectively corresponding to the dimensions from environment information corresponding to an unmanned driving environment;

an input module, configured to input the obtained information into a feature identification submodel of an identification model to obtain a driving feature outputted by the feature identification submodel, where when the driving feature is inputted into a risk determining submodel of the identification model, the risk determining submodel outputs a risk value representing a driving risk degree of an unmanned device;

a first determining module, configured to determine a maximum variation of the information corresponding to at least one of the dimensions in response to a variation of the driving feature being less than a predetermined threshold, and use a maximum variation of the information corresponding to each of the at least one of the dimensions as a risk contribution feature;

a second determining module, configured to, for each of the at least one of the dimensions, determine, from the risk contribution feature, a variation representative value of the information corresponding to the dimension; and

a third determining module, configured to, according to the variation representative value of the information corresponding to each of the at least one of the dimensions, determine, from the information corresponding to each of the at least one of the dimensions, a driving risk factor corresponding to the risk value determined based on the driving feature.

The present disclosure provides a non-transitory computer-readable storage medium, having stored thereon a computer program, the computer program, when being executed by a processor, causes the processor to implement the foregoing driving risk identification method.

Embodiments provide an electronic device, including a memory, a processor, and a computer program stored on the memory and executable on the processor, the processor is configured to, when executing the computer program, implement the foregoing driving risk identification method.

The at least one technical solution adopted in the embodiments of the present disclosure can achieve the following beneficial effects:

In the present disclosure, according to predetermined dimensions, information corresponding to each of the dimensions is extracted from environment information corresponding to an unmanned driving environment; the obtained information is inputted into a feature identification submodel of an identification model to obtain a driving feature outputted by the feature identification submodel, where when the driving feature is inputted into a risk determining submodel of the identification model, the risk determining submodel outputs a risk value representing a driving risk degree of an unmanned device; next, a maximum variation of the information corresponding to at least one dimension is determined under a condition that a variation of the driving feature is less than a predetermined threshold, and a maximum variation of the information corresponding to each dimension is used as a risk contribution feature; for each dimension, a variation representative value of the information corresponding to the dimension is determined from the risk contribution feature; and finally, a driving risk factor corresponding to the risk value determined based on the driving feature is determined from the information respectively corresponding to the dimensions according to the variation representative values of the information respectively corresponding to the dimensions. Through the above method, in the present disclosure, the driving risk degree of the unmanned device and the driving risk factor that leads to the driving risk degree of the unmanned device can be determined based on the environment information by using the identification model. That is, in various driving scenarios, through the present disclosure, whether there is a driving risk during the driving of the unmanned device or not and the driving risk factor when there is a driving risk can be identified by using the model.

### BRIEF DESCRIPTION OF DRAWINGS

Accompanying drawings described herein are used for providing further understanding about the present disclosure, and constitute a part of the present disclosure. Exemplary embodiments of the present disclosure and descriptions thereof are used for explaining the present disclosure, and do not constitute an inappropriate limitation on the present disclosure. In the accompanying drawings,

FIG. 1 is a flowchart of a driving risk identification method according to an embodiment of the present disclosure;

FIG. 2 is a schematic structural diagram of an identification model according to an embodiment of the present disclosure;

FIG. 3 is a flowchart of identifying a driving risk factor corresponding to a risk value determined based on a driving feature according to an embodiment of the present disclosure;

FIG. 4 is a schematic structural diagram of a driving risk identification apparatus according to an embodiment of the present disclosure; and

FIG. 5 is a schematic diagram of an electronic device configured to implement a driving risk identification method according to an embodiment of the present disclosure.

### DETAILED DESCRIPTION

To state the objectives, technical solutions, and advantages in accordance with the present disclosure, the technical solutions in accordance with the present disclosure will be described below with reference to embodiments herein and corresponding accompanying drawings. Apparently, the described embodiments are merely some but not all of the embodiments, and thus are not intended to be limiting. Based on the embodiments herein, all other embodiments obtained by a person of ordinary skill in the art without inventive efforts shall fall within the protection scope of the present disclosure.

An unmanned device may input driving data of the unmanned device and vehicles in the surrounding environment into a pre-trained model to obtain the driving risk level determined by the model. Although this method can be applied to various driving scenarios, the risk factor corresponding to the driving risk level cannot be determined in this method. Generally, the principle of machine learning-based risk identification is to continuously extract features from information inputted into the model, and then determine a risk value according to the features. The information inputted into the model is interpretable (understandable by humans), but the features continuously extracted by the model are often not interpretable (not understandable by humans). As a result, after the model finally gives the risk value, although the risk value in this case is obtained, main factors cannot be identified from the multidimensional information inputted into the model.

For example, clear day (weather dimension), light congestion (road condition dimension), 70 km/h (vehicle speed dimension) are inputted into a pre-trained risk identification model, and the risk identification model first extracts a driving feature from the inputted information. Finally, a risk value is obtained according to the driving feature. Suppose the risk value indicates a high risk. However, the driving feature extracted by the risk identification model (also referred to as identification model) from the inputted interpretable information is not interpretable. As a result, it can be learned only that the risk value in this case indicates a high risk, but the reason for the high risk in this case cannot be learned.

In view of this, to determine which driving risk factor the risk value is obtained based on by the identification model, the present disclosure provides a driving risk identification method.

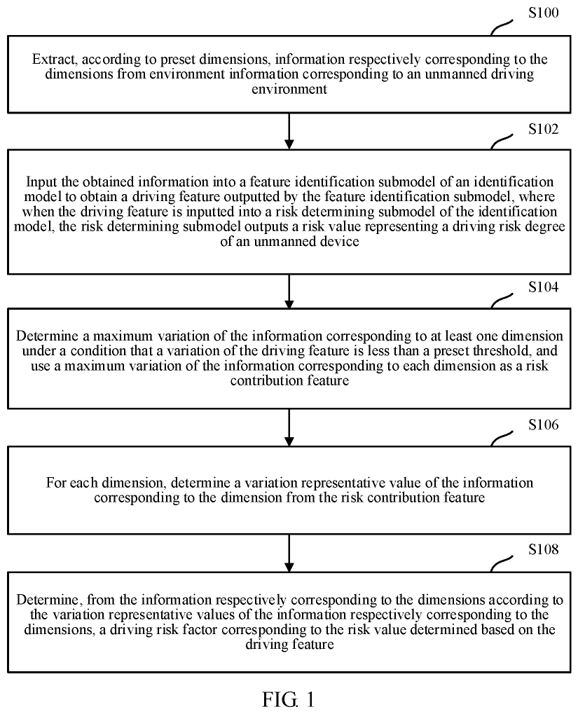

FIG. 1 is a flowchart of a driving risk identification method according to an embodiment of the present disclosure. The flowchart may specifically include the following steps:

S100: Extract, according to predetermined dimensions, information respectively corresponding to the dimensions from environment information corresponding to an unmanned driving environment.

In accordance with the present disclosure, an unmanned device, that is, an unmanned driving device, does not to be manually driven during driving, including an unmanned driving vehicle, an unmanned aerial vehicle, or another intelligent unmanned driving device, which can be configured to carry people or objects. When configured to carry objects, the unmanned device can be configured to replace human to deliver goods (for example, transport sorted goods in a large cargo storage center), or transport goods from one place to another.

The unmanned device can identify driving risks for operation during operation. Specifically, on the one hand, the unmanned device can identify whether there is a driving risk during operation. In other words, the unmanned device can determine whether the current operating status of the unmanned device is a safe driving state. If the determination result is a safe driving state, that is, the unmanned device identifies that there is no driving risk, and if the determination result is not a safe driving state, that is, the unmanned device identifies that there is a driving risk. On the other hand, the unmanned device can identify a driving risk factor when there is a driving risk, that is, when it is determined that the unmanned device is not in a safe driving state currently, the unmanned device can determine the driving risk factor that causes the unmanned device to be not in a safe driving state currently.

Generally, the driving risk factor may be determined based on information of the unmanned device, information of obstacles in a surrounding environment of the unmanned device, environment information of the surrounding environment of the unmanned device, interaction information between the unmanned device and the obstacles, and the like. Certainly, the unmanned device also identifies whether there is a driving risk during operation based on the foregoing information.

Therefore, the unmanned device may obtain environment information corresponding to an unmanned driving environment. The environment information corresponding to the unmanned driving environment may include the information of the unmanned device, the information of the obstacles in the surrounding environment of the unmanned device, the environment information of the surrounding environment of the unmanned device, and the interaction information between the unmanned device and the obstacles.

The information of the unmanned device may include status information of the unmanned device, for example, the speed, acceleration, yaw rotation angle, steering entropy, and other information of the unmanned device. The steering entropy may be used for measuring the directional control characteristics of the vehicle, and may reflect the steering smooth degree and driving safety of the vehicle, and may further include other information related to the unmanned device, such as the current location of the unmanned device and the vehicle type to which the unmanned device belongs.

With reference to the information of the unmanned device, for each of the obstacles, the information of the obstacle may also include status information such as speed and acceleration, and other information such as location and vehicle type.

The environment information of the surrounding environment of the unmanned device may include road speed limit information of a lane at which the unmanned device is currently located, the lane line type of the lane at which the unmanned device is currently located, the distance between the current location of the unmanned device and each of lane lines on both sides, and the like. In addition, the environment information of the surrounding environment of the unmanned device may further include weather information and the like, which will not be listed herein one by one.

The interaction information between the unmanned device and each obstacle may be determined based on the information of the unmanned device and the information of the each obstacle, and may include information such as a speed difference between the unmanned device and the each obstacle, and relative positions. In addition, the interaction information may further include information such as time headway (THW), distance headway (DHW), and time-to-collision (TTC).

In the present disclosure, dimensions may be predetermined, and information types of the dimensions are determined, so that when the information corresponding to each dimension is extracted from the environment information corresponding to the unmanned driving environment, for the each dimension, the information corresponding to the dimension can be extracted from the environment information corresponding to the unmanned driving environment according to the information type corresponding to the dimension.

In some embodiments, the information type of each dimension may be set based on an actual situation. For example, based on experience, factors of driving risks usually include the vehicle speed, the safe distance between vehicles, current driving stability of the vehicle, weather conditions, road conditions, and the like. Therefore, a speed dimension, a distance dimension, a weather dimension, a road condition dimension, and the like may be set. Specifically, a weather dimension, a road condition dimension, a speed dimension of the unmanned device, an acceleration dimension of the unmanned device, a distance dimension between the unmanned device and the obstacles may be set. Using the speed dimension of the unmanned device as an example, in the present disclosure, speed information of the unmanned device may be extracted from the information of the unmanned device, and the extracted speed information is used as information corresponding to the speed dimension of the unmanned device.

Certainly, other information types of dimensions may be further set in the present disclosure, and the common information types in the dimensions are merely listed as examples herein. For other information types, details are not described again in the present disclosure.

S102: Input the obtained information into a feature identification submodel of an identification model to obtain a driving feature outputted by the feature identification submodel, where when the driving feature is inputted into a risk determining submodel of the identification model, the risk determining submodel outputs a risk value representing a driving risk degree of an unmanned device.

After the information respectively corresponding to the dimensions is extracted, the extracted information may be inputted into the identification model, so that the driving feature and the risk value are obtained through the identification model. The identification model may be configured to determine the risk value representing the driving risk degree of the unmanned device, and may include the feature identification submodel and the risk determining submodel. The identification model may be a pre-trained machine learning model, for example, a recurrent neural network (RNN) model, a long short-term memory (LSTM) model, or another neural network model.

Input information of the identification model is the information respectively corresponding to the dimensions, and output information is the risk value. The feature identification submodel may be configured to determine a feature of the information respectively corresponding to the dimensions, and therefore, the input information of the feature identification submodel is the information respectively corresponding to the dimensions, and the output information is the driving feature. The risk determining submodel may determine the risk value based on the driving feature, and therefore, the input information of the risk determining submodel is the driving feature, and the output information is the risk value.

The specific process of inputting the information respectively corresponding to the dimensions into the identification model to obtain the risk value is described below.

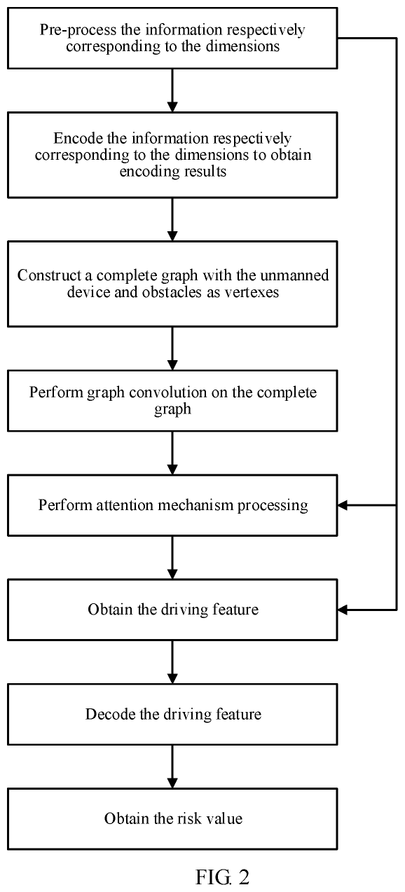

FIG. 2 is a schematic structural diagram of an identification model according to an embodiment of the present disclosure. As shown in FIG. 2, the information respectively corresponding to the dimensions is pre-processed first.

In some embodiments, when the environment information corresponding to the unmanned driving environment is obtained, data of the environment information corresponding to the unmanned driving environment in the Frenet coordinate system may be obtained. For ease of calculation, coordinate transformation may be performed on the data of the information respectively corresponding to the dimensions in the Frenet coordinate system. That is, a global coordinate system with the unmanned device as the origin of coordinates may be established. Specifically, the global coordinate system may be established with the center point of the unmanned device or the center point of the rear axle of the unmanned device as the origin of coordinates, and the data of the information respectively corresponding to the dimensions in the Frenet coordinate system is transformed into data of the information respectively corresponding to the dimensions in the global coordinate system.

Next, the information of the dimensions after the coordinate transformation is inputted into the feature identification submodel to obtain the driving feature.

For example, the information respectively corresponding to the dimensions may be classified. For example, if the information is classified according to types of the information respectively corresponding to the dimensions, a first set including the information of the unmanned device, a second set including the information of the obstacles, and a third set including the interaction information between the unmanned device and the obstacles and the environment information of the surrounding environment of the unmanned device may be obtained. Certainly, the present disclosure may also support the classification of the information respectively corresponding to the dimensions according to other classification rules.

After the information respectively corresponding to the dimensions is classified, the information respectively corresponding to the dimensions may be encoded. Based on the foregoing example, the information in the first set and the second set may be encoded respectively to obtain a first encoding result and a second encoding result. In addition, the information in the third set may be encoded to obtain a third encoding result. A complete graph with the unmanned device and the obstacles as vertexes may be constructed according to the encoding results, and graph convolution is performed on the complete graph.

An adjacency matrix that represents the complete graph may be obtained according to the first encoding result and the second encoding result. The complete graph with the unmanned device and the obstacles as vertexes may be constructed according to the adjacency matrix. In the complete graph, the information of the vertex is the information of the unmanned device or the information of the obstacle. The relationship between the vertex representing the unmanned device and the vertex representing the obstacle may be expressed by the distance between the information of the unmanned device and the information of the obstacle, and the distance between the information of the unmanned device and the information of the obstacle may be represented by the Euclidean distance. After the complete graph is constructed, graph convolution may be performed on the complete graph according to a predetermined convolution weight. For the process of performing graph convolution on the complete graph, reference may be made to the existing technical solutions.

After the graph convolution is performed on the complete graph, attention mechanism processing may be performed on a graph convolution result, and the driving feature may be obtained according to an attention mechanism processing result.

The graph convolution result may be inputted into a first fully-connected layer and a second fully-connected layer respectively to obtain a first feature and a second feature. The first feature is used as a Key value of an attention mechanism, and the second feature is used as a Value value of the attention mechanism. In addition, the third encoding result may be obtained, and a result obtained by inputting the third encoding result into a third fully-connected layer is used as a Query value of the attention mechanism, so that attention mechanism processing is performed according to the Key value, the Value value and the Query value of the attention mechanism to obtain the attention mechanism processing result. The attention mechanism herein may be a multi-head attention mechanism, and the quantity of heads of the attention mechanism may be set according to an actual situation. In the present disclosure, the attention mechanism processing result may be inputted into a fourth fully-connected layer and activated, and an obtained result may be connected to the third encoding result to obtain the driving feature.

Finally, the driving feature is inputted into the risk determining submodel to obtain the risk value.

For example, the driving feature may be inputted into the risk determining submodel and decoded by the risk determining submodel. A decoding result is inputted into an activation layer to obtain the risk value.

It should be noted that, in the present disclosure, the information respectively corresponding to the dimensions may be inputted into the identification model to obtain the risk value, and whether there is a driving risk in the operation of the unmanned device may be identified according to a predetermined risk threshold, that is, identified by determining whether the risk value is less than the risk threshold. If a determination result indicates the risk value is less than the risk threshold, it indicates that there is no driving risk during the operation of the unmanned device. In this case, there is no need to analyze a driving risk factor. If the determination result indicates the risk value is not less than the risk threshold, it indicates that there is a driving risk during the operation of the unmanned device. In this case, the driving risk factor may be identified according to step S104 to step S108. In addition, in the present disclosure, after the information respectively corresponding to the dimensions is inputted into the identification model, only the driving feature is to be obtained, and there is no need to obtain the risk value. Whether there is a driving risk during the operation of the unmanned device cannot be identified by using the driving feature, that is, the driving feature may be a feature of the unmanned device when there is a driving risk or a feature of the unmanned device when there is no driving risk. Therefore, in the present disclosure, the driving risk factor may be also identified by using the driving feature based on step S104 to step S108.

S104: Determine a maximum variation of the information corresponding to at least one dimension under a condition that a variation of the driving feature is less than a predetermined threshold, and use a maximum variation of the information corresponding to each dimension as a risk contribution feature.

S106: For each dimension, determine a variation representative value of the information corresponding to the dimension from the risk contribution feature.

S108: Determine, from the information respectively corresponding to the dimensions according to the variation representative values of the information respectively corresponding to the dimensions, a driving risk factor corresponding to the risk value determined based on the driving feature.

In accordance with the present disclosure, the core idea of determining, from the information respectively corresponding to the dimensions, the driving risk factor corresponding to the risk value determined based on the driving feature is to add a variation to the information corresponding to each of the dimensions, and the information respectively corresponding to the dimensions after the variations are added is input into the identification model to re-obtain a driving feature as an updated feature. In a case that a difference between the updated feature and the driving feature is smallest (which may be zero or may be less than the predetermined threshold), for each dimension, the maximum variation of the information corresponding to the dimension is determined. A greater maximum variation indicates smaller impact of the information corresponding to the dimension on determining the driving feature, that is, the possibility that the information corresponding to the dimension is the driving risk factor is smaller. On the contrary, a smaller maximum variation indicates greater impact of the information corresponding to the dimension on determining the driving feature, that is, the possibility that the information corresponding to the dimension is the driving risk factor is greater.

In the core idea, the driving feature may be replaced with the risk value. When the driving feature is replaced with the risk value, the risk value may be determined by using the identification model in the present disclosure or may be determined by using another machine learning model with the ability to determine the risk value in the technical solutions well known to those skilled in the art.

In an example in which the dimensions include weather, road condition, the speed of the unmanned device, clear day (weather dimension), light congestion (road condition dimension), 70 km/h (dimension of the speed of the unmanned device) are inputted into a pre-trained risk identification model, and the risk identification model first extracts a first driving feature from the inputted information and finally obtains a risk value according to the first driving feature. Suppose the risk value indicates a high risk. If the information of the weather dimension inputted into the identification model is changed from clear day to heavy rain, and the information of other dimensions remains unchanged, all the information is inputted into the identification model again. In this case, if a difference between a second driving feature obtained by the identification model based on the information and the first driving feature is small, it may indicate that the information of the weather dimension is not the main driving risk factor leading to the previously obtained high risk, that is, the information of the weather dimension is not the driving risk factor corresponding to the high risk.

If the information of the dimension of the speed of the unmanned device inputted into the identification model is changed from 70 km/h to 65 km/h, and the information of other dimensions remains unchanged, all the information is inputted into the identification model again. In this case, if a difference between a third driving feature obtained by the identification model and the first driving feature is large, it may indicate that the information of the dimension of the speed of the unmanned device is the main driving risk factor leading to the previously obtained high risk, that is, the information of the dimension of the speed of the unmanned device is the driving risk factor corresponding to the high risk.

For ease of description, in the present disclosure, the process of identifying the driving risk factor is described by using an example in which the driving feature is determined by using the identification model.

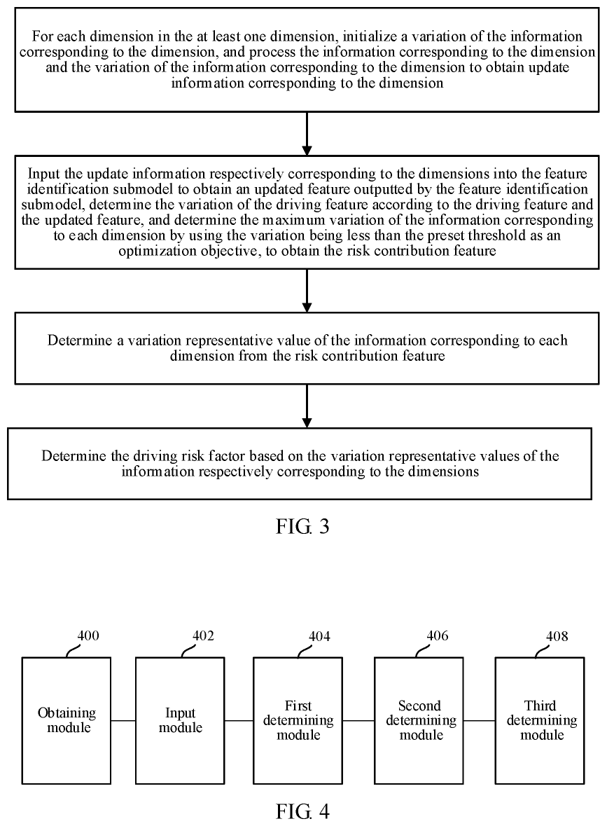

FIG. 3 is a flowchart of identifying a driving risk factor corresponding to a risk value determined based on a driving feature according to an embodiment of the present disclosure. As shown in FIG. 3, first, for each dimension in the at least one dimension, a variation of the information corresponding to the dimension is initialized, and the information corresponding to the dimension and the variation of the information corresponding to the dimension are processed to obtain updated information corresponding to the dimension.

For example, for each dimension, the information of the dimension is normalized according to the information corresponding to the dimension. A normalization result is compensated according to the variation of the information corresponding to the dimension to obtain the updated information corresponding to the dimension.

During the normalization of the information respectively corresponding to the dimensions, the normalization may be formed in a manner of determining variances of the information respectively corresponding to the dimensions. In addition, the present disclosure may also support other methods to normalize the information respectively corresponding to the dimensions. It should be noted that, through the normalization of the information respectively corresponding to the dimensions, values of the information respectively corresponding to the dimensions may be mapped to the same value space, which is more conducive to comparison of the variations of the information respectively corresponding to the dimensions (especially the maximum variations) to determine the driving risk factor.

After the information respectively corresponding to the dimensions is normalized, for each of the dimensions, the variation of the information corresponding to the dimension may be initialized, and the variation of the information corresponding to the dimension is added to the information corresponding to the dimension to obtain the updated information corresponding to the dimension, that is, the updated information is information added with the variation of the information.

Next, the updated information respectively corresponding to the dimensions is inputted into the feature identification submodel to obtain an updated feature outputted by the feature identification submodel, the variation of the driving feature is determined according to the driving feature and the updated feature, and the maximum variation of the information corresponding to each dimension is determined by using the variation being less than the predetermined threshold as an optimization objective, to obtain the risk contribution feature.

For example, the updated information respectively corresponding to the dimensions is inputted into the feature identification submodel to obtain the updated feature, that is, the updated feature is a driving feature of the information that is added with the variations and that respectively corresponds to the dimensions. When the variation between the driving feature and the updated feature is determined, a norm of a difference between the driving feature and the updated feature may be determined, and a negative correlation function of the variation of the information corresponding to each dimension is determined. The variation between the driving feature and the updated feature is determined according to the norm and the negative correlation function. Determining the maximum variation of the information corresponding to each dimension by using the variation being less than the predetermined threshold as an optimization objective is actually an optimization algorithm of determining the maximum variation of the information corresponding to each dimension under the condition that the variation is less than the predetermined threshold. Therefore, the concept of loss may be described in the present disclosure, that is, the loss is determined according to the driving feature, the updated feature, and the variation of the information corresponding to the each dimension. The variation of the information corresponding to the each dimension is adjusted by using loss minimization as an optimization objective, and the maximum variation of the information corresponding to the each dimension is used as the risk contribution feature.

A log likelihood function loss may be determined according to the norm of the difference between the driving feature and the updated feature, and an information entropy loss is determined according to the negative correlation function of the variation. The information entropy loss may be a log function. The sum of the log likelihood function loss and the information entropy loss is determined as the final loss.

In accordance with the present disclosure, for each dimension, the loss may be determined in a case that the information corresponding to the dimension is added with the variation and the information respectively corresponding to other dimensions is not added with the variations. That is, the difference between the updated feature and the driving feature is caused merely by the variation of the information corresponding to the dimension. The maximum variation of the information corresponding to the dimension is determined by using loss minimization as an optimization objective. Similarly, the maximum variation of the information corresponding to each dimension is obtained and used as a risk contribution feature.

In addition, in accordance with the present disclosure, variations may be simultaneously added to the information respectively corresponding to the dimensions. Values of the variations of the information respectively corresponding to the dimensions do not interfere with each other. That is, the variations of the information corresponding to any two dimensions may be the same or different, and the loss is determined in this case. That is, the difference between the updated feature and the driving feature is jointly caused by the variations of the information respectively corresponding to the dimensions, and the maximum variations of the information respectively corresponding to the dimensions are determined by using loss minimization as an optimization objective. In this case, the maximum variation is jointly determined by the variations of the information respectively corresponding to the dimensions and used as the risk contribution feature.

Next, a variation representative value of the information corresponding to each dimension is determined from the risk contribution feature.

For example, as described in the above, if the risk contribution feature is determined by determining the maximum variation of the information corresponding to each dimension, for the each dimension, the variation representative value of the information corresponding to the dimension in the risk contribution feature is the maximum variation of the information corresponding to the dimension. That is, if the maximum variation of the information corresponding to the i^{th} dimension is determined as x_{i,max}, the risk contribution feature X may be represented as {x_{i,max}}_{i=1, 2 . . . n}, where n is the quantity of the dimensions, and the variation representative value of the information corresponding to the i^{th} dimension is x_{i,max}.

If the risk contribution feature is determined by simultaneously determining the maximum variations of the information respectively corresponding to the dimensions, for each of the dimensions, the variation representative value of the information corresponding to the dimension is the variation of the information corresponding to the dimension in the risk contribution feature. That is, if the variation of the information corresponding to the i^{th} dimension is determined as xᵢ, the maximum variation of the information corresponding to each dimension is (that is, the risk contribution feature Xₘₐₓ) {x}_{i=1,2 . . . n}, and the variation representative value of the information corresponding to the i^{th} dimension is xᵢ.

Finally, the driving risk factor is determined based on the variation representative values of the information respectively corresponding to the dimensions.

For example, given the core idea of determining the driving risk factor corresponding to the risk value determined based on the driving feature described in the above, when the driving risk factor is determined from the information respectively corresponding to the dimensions, impact of the information respectively corresponding to the dimensions on determining the driving feature may be determined based on the variation representative values of the information respectively corresponding to the dimensions, so that the information that has a greater impact on determining the driving feature is selected from the information respectively corresponding to the dimensions and used as the driving risk factor.

Therefore, the information respectively corresponding to the dimensions may be ranked according to the variation representative values of the information respectively corresponding to the dimensions, and the driving risk factor is determined from the information respectively corresponding to the dimensions according to a ranking result. For example, the variation representative values of the information respectively corresponding to the dimensions may be ranked in ascending order, and types of information with top rankings may be selected as driving risk factors from the information respectively corresponding to the dimensions.

In addition, a variation threshold may be predetermined. For each dimension, it is determined whether the variation representative value of the information corresponding to the dimension is less than the variation threshold. If a determination result indicates that the variation representative value is less than the variation threshold, the information corresponding to the dimension is determined as the driving risk factor. Otherwise, it is determined that the information corresponding to the dimension is not the driving risk factor.

The driving risk identification method provided in the present disclosure may be specifically applied to the field of delivery using unmanned devices, for example, express delivery or takeaway delivery using unmanned devices. Specifically, in the foregoing scenarios, an unmanned driving fleet including a plurality of unmanned devices may be used for delivery.

Based on the driving risk identification method described in the above, the embodiments of the present disclosure further provide a schematic structural diagram of a driving risk identification apparatus correspondingly as shown in FIG. 4.

FIG. 4 is a schematic structural diagram of a driving risk identification apparatus according to an embodiment of the present disclosure. The apparatus includes:

an obtaining module 400, configured to extract, according to predetermined dimensions, information respectively corresponding to the dimensions from environment information corresponding to an unmanned driving environment;

an input module 402, configured to input the obtained information into a feature identification submodel of an identification model to obtain a driving feature outputted by the feature identification submodel, where when the driving feature is inputted into a risk determining submodel of the identification model, the risk determining submodel outputs a risk value representing a driving risk degree of an unmanned device;

a first determining module 404, configured to determine a maximum variation of the information corresponding to at least one dimension in the dimensions under a condition that a variation of the driving feature is less than a predetermined threshold, and use a maximum variation of the information corresponding to each dimension in the at least one dimension as a risk contribution feature;

a second determining module 406, configured to, for each dimension in the at least one dimension, determine a variation representative value of the information corresponding to the dimension from the risk contribution feature; and

a third determining module 408, configured to determine, from the information respectively corresponding to the dimensions in the at least one dimension according to the variation representative values of the information respectively corresponding to the dimensions in the at least one dimension, a driving risk factor corresponding to the risk value determined based on the driving feature.

Through the above method, in the present disclosure, the driving risk degree of the unmanned device and the driving risk factor that leads to the driving risk degree of the unmanned device can be determined based on the environment information by using the identification model. That is, in various driving scenarios, through the present disclosure, whether there is a driving risk during the driving of the unmanned device or not and the driving risk factor when there is a driving risk can be identified by using the model.

In some embodiments, the environment information includes: status information of the unmanned device, information of obstacles in a surrounding environment of the unmanned device, environment information of the surrounding environment of the unmanned device, and interaction information between the unmanned device and the obstacles; and the dimensions include a speed dimension and a distance dimension.

In some embodiments, the input module 402 is further configured to encode the information respectively corresponding to the dimensions by using the identification model; construct a complete graph with the unmanned device and obstacles as vertexes according to encoding results, perform graph convolution on the complete graph, and perform attention mechanism processing on a graph convolution result; and obtain the driving feature according to an attention mechanism processing result.

In some embodiments, the first determining module 404 is further configured to: for each dimension in the at least one dimension, initialize a variation of the information corresponding to the dimension, and process the information corresponding to the dimension and the variation of the information corresponding to the dimension to obtain updated information corresponding to the dimension; input the updated information respectively corresponding to the dimensions into the feature identification submodel to obtain an updated feature outputted by the feature identification submodel; and determine the variation of the driving feature according to the driving feature and the updated feature, and determine the maximum variation of the information corresponding to each dimension by using the variation being less than the predetermined threshold as an optimization objective, to obtain the risk contribution feature.

In some embodiments, the first determining module 404 is further configured to: for each dimension in the at least one dimension, normalize the information of the dimension according to the information corresponding to the dimension; and compensate a normalization result according to the variation of the information corresponding to the dimension to obtain the updated information corresponding to the dimension.

In some embodiments, the first determining module 404 is further configured to: determine a norm of a difference between the driving feature and the updated feature according to the driving feature and the updated feature; for each dimension in the at least one dimension, determine a negative correlation function of the variation of the information corresponding to the dimension; and determine the variation of the driving feature according to the norm and the negative correlation function of each dimension in the at least one dimension.

In some embodiments, the third determining module 408 is further configured to: rank the information respectively corresponding to the dimensions in the at least one dimension according to the variation representative values of the information respectively corresponding to the dimensions in the at least one dimension; and determine the driving risk factor from the information respectively corresponding to the dimensions according to a ranking result.

The embodiments of the present disclosure further provide a computer-readable storage medium, storing a computer program. The computer program may be used for performing the driving risk identification method described in the above.

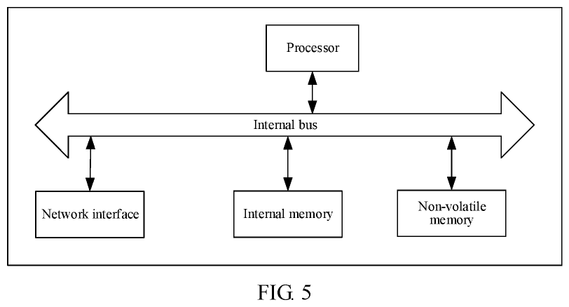

Based on the driving risk identification method described in the above, the embodiments of the present disclosure further provide a schematic structural diagram of an electronic device shown in FIG. 5. Referring to FIG. 5, at a hardware level, the electronic device includes a processor, an internal bus, a network interface, an internal memory, and a non-volatile memory, and may certainly further include hardware required for other services. The processor reads a corresponding computer program from the non-volatile storage into the memory and then runs the computer program to implement the driving risk identification method described in the above.

Definitely, in addition to a software implementation, the present disclosure does not exclude other implementations, for example, a logic device or a combination of software and hardware. In other words, an entity executing the following processing procedure is not limited to the logic units, and may also be hardware or logic devices.

In the 1990s, improvements of a technology can be clearly distinguished between hardware improvements (for example, improvements to a circuit structure such as a diode, a transistor, or a switch) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented by using a hardware entity module. For example, a programmable logic device (PLD) such as a field programmable gate array (FPGA) is a type of integrated circuit whose logic function is determined by a user by programming the device. The designers perform voluntary programming to “integrate” a digital system into a single PLD without requiring a chip manufacturer to design and prepare a dedicated integrated circuit chip. Moreover, nowadays, instead of manually making integrated circuit chips, this programming is mostly implemented by using “logic compiler” software, which is similar to the software compiler used in program development and writing. The original code is written in a specific programming language before compiling, and this language is referred to as a hardware description language (HDL). There are various kinds of HDLs, for example, advanced Boolean expression language (ABEL), altera hardware description language (AHDL), Confluence, Cornell university programming language (CUPL), HDCal, Java hardware description language (JHDL), Lava, Lola, MyHDL, PALASM, Ruby hardware description language (RHDL), and the like. Currently, the most commonly used HDLs are very-high-speed integrated circuit hardware description language (VHDL) and Verilog. A person skilled in the art should also understand that provided that a method procedure is logically programmed and then programmed to an integrated circuit by using the foregoing hardware description languages, a hardware circuit that implements the logical method procedure can be easily obtained.

The controller can be implemented in any suitable manner, for example, the controller can take the form of, for example, a microprocessor or processor and a computer-readable medium storing computer-readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20, and Silicone Labs C8051F320. The memory controller can also be implemented as part of the memory control logic. A person skilled in the art will also appreciate that, in addition to implementing the controller in the form of pure computer-readable program code, it is also possible to implement, by logically programming the method steps, the controller in the form of a logic gate, switch, ASIC, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module or the unit described in the foregoing embodiments may be implemented by a computer chip or an entity specifically, or implemented by a product having a certain function. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, during implementation of the present disclosure, the functions of the units may be implemented in the same piece of or a plurality of pieces of software and/or hardware.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can instruct a computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and a memory.

The memory may include a form such as a volatile memory, a random-access memory (RAM) and/or a non-volatile memory such as a read-only memory (ROM) or a flash RAM in a computer-readable medium. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition in the present disclosure, the computer-readable medium does not include transitory computer readable media (transitory media), such as a modulated data signal and a carrier.

It should be further noted that the term “include,” “comprise,” or any other variants are intended to cover a non-exclusive inclusion, so that a process, a method, a commodity, or a device that includes a series of elements not only includes such elements, but also includes other elements not expressly listed, or further includes elements inherent to such a process, method, commodity, or device. Unless otherwise specified, an element limited by “include a/an . . . ” does not exclude other same elements existing in the process, the method, the article, or the device that includes the element.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

The present disclosure can be described in the general context of computer-executable instructions executed by a computer, for example, program modules. Generally, the program module includes a routine, a program, an object, a component, a data structure, and the like for executing a particular task or implementing a particular abstract data type. The present disclosure may also be implemented in a distributed computing environment in which tasks are performed by remote processing devices connected by using a communication network. In a distributed computing environment, the program module may be located in both local and remote computer storage media including storage devices.

The embodiments of the present disclosure are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The descriptions are merely embodiments of the present disclosure, and are not intended to limit the present disclosure. For a person skilled in the art, various modifications and changes may be made to the present disclosure. Any modifications, equivalent replacements, and improvements made within the spirit and principle of the present disclosure shall fall within the scope of the claims of the present disclosure.

What is claimed is:

1. A driving risk identification method, comprising:
extracting, according to predetermined dimensions, information respectively corresponding to the predetermined dimensions from environment information corresponding to an unmanned driving environment;
inputting the information respectively corresponding to the predetermined dimensions into a feature identification submodel of an identification model to obtain a driving feature outputted by the feature identification submodel, wherein when the driving feature is inputted into a risk determining submodel of the identification model, the risk determining submodel outputs a risk value representing a driving risk degree of an unmanned device;
determining a maximum variation of the information corresponding to at least one of the dimensions in response to a variation of the driving feature being less than a predetermined threshold, and using a maximum variation of the information corresponding to each of the at least one of the predetermined dimensions as a risk contribution feature;
for each of the at least one of the predetermined dimensions, determining, from the risk contribution feature, a variation representative value of the information corresponding to the predetermined dimension; and
according to the variation representative value of the information corresponding to each of the at least one of the predetermined dimensions, determining, from the information corresponding to each of the at least one of the predetermined dimensions, a driving risk factor corresponding to the risk value determined based on the driving feature.

2. The method according to claim 1, wherein the environment information comprises: status information of the unmanned device, information of obstacles in a surrounding environment of the unmanned device, environment information of the surrounding environment of the unmanned device, and interaction information between the unmanned device and the obstacles; and, wherein the predetermined dimensions comprise a speed dimension and a distance dimension.

3. The method according to claim 1, wherein inputting the information respectively corresponding to the predetermined dimensions into the feature identification submodel of the identification model to obtain the driving feature outputted by the feature identification submodel comprises:
encoding the information respectively corresponding to the predetermined dimensions by using the identification model;
constructing a complete graph with the unmanned device and obstacles as vertexes according to encoding results, performing graph convolution on the complete graph, and performing attention mechanism processing on a graph convolution result; and
obtaining the driving feature according to an attention mechanism processing result.

4. The method according to claim 1, wherein determining the maximum variation of the information corresponding to the at least one of the predetermined dimensions in response to the variation of the driving feature being less than the predetermined threshold, and using the maximum variation of the information corresponding to each dimension in the at least one of the predetermined dimensions as the risk contribution feature comprises:
for each of the at least one of the predetermined dimensions, initializing a variation of the information corresponding to the predetermined dimension, and processing the information corresponding to the dimension and the variation of the information corresponding to the dimension to obtain updated information corresponding to the dimension;
inputting the updated information respectively corresponding to the at least one of the predetermined dimensions into the feature identification submodel to obtain an updated feature outputted by the feature identification submodel; and
determining the variation of the driving feature according to the driving feature and the updated feature, and with the variation being less than the predetermined threshold as an optimization objective, determining the maximum variation of the information corresponding to each of the at least one of the dimensions, to obtain the risk contribution feature.

5. The method according to claim 4, wherein processing the information corresponding to the dimension and the variation of the information corresponding to the dimension to obtain updated information corresponding to the dimension comprises:
normalizing the information corresponding to the dimension; and
compensating a normalization result according to the variation of the information corresponding to the dimension to obtain the updated information corresponding to the dimension.

6. The method according to claim 4, wherein determining the variation of the driving feature according to the driving feature and the updated feature comprises:
determining a norm of a difference between the driving feature and the updated feature according to the driving feature and the updated feature;
for each of the at least one of the predetermined dimensions, determining a negative correlation function of the variation of the information corresponding to the dimension; and
determining the variation of the driving feature according to the norm and the negative correlation function of each of the at least one of the dimensions.

7. The method according to claim 1, wherein according to the variation representative value of the information corresponding to each of the at least one of the predetermined dimensions, determining, from the information corresponding to each of the at least one of the predetermined dimensions, the driving risk factor corresponding to the risk value determined based on the driving feature comprises:
ranking the information corresponding to each of the at least one of the predetermined dimensions according to the variation representative value of the information corresponding to each of the at least one of the dimensions; and
determining, from the information corresponding to each of the at least one of the predetermined dimensions, the driving risk factor according to a ranking result.

8. A non-transitory computer-readable storage medium, having stored thereon a computer program, the computer program, when being executed by a processor, causes the processor to implement operations comprising:
extracting, according to dimensions which are predetermined, information respectively corresponding to the predetermined dimensions from environment information corresponding to an unmanned driving environment;
inputting the information respectively corresponding to the predetermined dimensions into a feature identification submodel of an identification model to obtain a driving feature outputted by the feature identification submodel, wherein when the driving feature is inputted into a risk determining submodel of the identification model, the risk determining submodel outputs a risk value representing a driving risk degree of an unmanned device;
determining a maximum variation of the information corresponding to at least one of the predetermined dimensions in response to a variation of the driving feature being less than a predetermined threshold, and using a maximum variation of the information corresponding to each of the at least one of the predetermined dimensions as a risk contribution feature;
for each of the at least one of the predetermined dimensions, determining, from the risk contribution feature, a variation representative value of the information corresponding to the dimension; and
according to the variation representative value of the information corresponding to each of the at least one of the predetermined dimensions, determining, from the information corresponding to each of the at least one of the predetermined dimensions, a driving risk factor corresponding to the risk value determined based on the driving feature.

9. The non-transitory computer-readable storage medium according to claim 8, wherein the environment information comprises: status information of the unmanned device, information of obstacles in a surrounding environment of the unmanned device, environment information of the surrounding environment of the unmanned device, and interaction information between the unmanned device and the obstacles; and the predetermined dimensions comprise a speed dimension and a distance dimension.

10. The non-transitory computer-readable storage medium according to claim 8, wherein inputting the information respectively corresponding to the predetermined dimensions into the feature identification submodel of the identification model to obtain the driving feature outputted by the feature identification submodel comprises:
encoding the information respectively corresponding to the predetermined dimensions by using the identification model;
constructing a complete graph with the unmanned device and obstacles as vertexes according to encoding results, performing graph convolution on the complete graph, and performing attention mechanism processing on a graph convolution result; and
obtaining the driving feature according to an attention mechanism processing result.

11. The non-transitory computer-readable storage medium according to claim 8, wherein determining the maximum variation of the information corresponding to the at least one of the predetermined dimensions in response to the variation of the driving feature being less than the predetermined threshold, and using the maximum variation of the information corresponding to each dimension in the at least one of the predetermined dimensions as the risk contribution feature comprises:
for each of the at least one of the predetermined dimensions, initializing a variation of the information corresponding to the dimension, and processing the information corresponding to the dimension and the variation of the information corresponding to the dimension to obtain updated information corresponding to the dimension;
inputting the updated information respectively corresponding to the at least one of the predetermined dimensions into the feature identification submodel to obtain an updated feature outputted by the feature identification submodel; and
determining the variation of the driving feature according to the driving feature and the updated feature, and with the variation being less than the predetermined threshold as an optimization objective, determining the maximum variation of the information corresponding to each of the at least one of the predetermined dimensions, to obtain the risk contribution feature.

12. The non-transitory computer-readable storage medium according to claim 11, wherein processing the information corresponding to the dimension and the variation of the information corresponding to the dimension to obtain updated information corresponding to the dimension comprises:
normalizing the information corresponding to the dimension; and
compensating a normalization result according to the variation of the information corresponding to the dimension to obtain the updated information corresponding to the dimension.

13. The non-transitory computer-readable storage medium according to claim 11, wherein determining the variation of the driving feature according to the driving feature and the updated feature comprises:
determining a norm of a difference between the driving feature and the updated feature according to the driving feature and the updated feature;
for each of the at least one of the predetermined dimensions, determining a negative correlation function of the variation of the information corresponding to the dimension; and
determining the variation of the driving feature according to the norm and the negative correlation function of each of the at least one of the predetermined dimensions.

14. An electronic device, comprising a memory, a processor, and a computer program stored on the memory and executable on the processor such that when the processor executes the computer program, the processor is caused to perform:
extracting, according to predetermined dimensions, information respectively corresponding to the predetermined dimensions from environment information corresponding to an unmanned driving environment;
inputting the information respectively corresponding to the predetermined dimensions into a feature identification submodel of an identification model to obtain a driving feature outputted by the feature identification submodel, wherein when the driving feature is inputted into a risk determining submodel of the identification model, the risk determining submodel outputs a risk value representing a driving risk degree of an unmanned device;
determining a maximum variation of the information corresponding to at least one of the predetermined dimensions in response to a variation of the driving feature being less than a predetermined threshold, and using a maximum variation of the information corresponding to each of the at least one of the predetermined dimensions as a risk contribution feature;
for each of the at least one of the predetermined dimensions, determining, from the risk contribution feature, a variation representative value of the information corresponding to the dimension; and
according to the variation representative value of the information corresponding to each of the at least one of the predetermined dimensions, determining, from the information corresponding to each of the at least one of the predetermined dimensions, a driving risk factor corresponding to the risk value determined based on the driving feature.

15. The electronic device according to claim 14, wherein the environment information comprises: status information of the unmanned device, information of obstacles in a surrounding environment of the unmanned device, environment information of the surrounding environment of the unmanned device, and interaction information between the unmanned device and the obstacles; and the predetermined dimensions comprise a speed dimension and a distance dimension.

16. The electronic device according to claim 14, wherein inputting the information respectively corresponding to the predetermined dimensions into the feature identification submodel of the identification model to obtain the driving feature outputted by the feature identification submodel comprises:
encoding the information respectively corresponding to the predetermined dimensions by using the identification model;
constructing a complete graph with the unmanned device and obstacles as vertexes according to encoding results, performing graph convolution on the complete graph, and performing attention mechanism processing on a graph convolution result; and
obtaining the driving feature according to an attention mechanism processing result.

17. The electronic device according to claim 14, wherein determining the maximum variation of the information corresponding to the at least one of the predetermined dimensions in response to the variation of the driving feature being less than the predetermined threshold, and using the maximum variation of the information corresponding to each dimension in the at least one of the predetermined dimensions as the risk contribution feature comprises:
for each of the at least one of the predetermined dimensions, initializing a variation of the information corresponding to the dimension, and processing the information corresponding to the dimension and the variation of the information corresponding to the dimension to obtain updated information corresponding to the dimension;
inputting the updated information respectively corresponding to the at least one of the predetermined dimensions into the feature identification submodel to obtain an updated feature outputted by the feature identification submodel; and
determining the variation of the driving feature according to the driving feature and the updated feature, and with the variation being less than the predetermined threshold as an optimization objective, determining the maximum variation of the information corresponding to each of the at least one of the predetermined dimensions, to obtain the risk contribution feature.

18. The electronic device according to claim 17, wherein processing the information corresponding to the dimension and the variation of the information corresponding to the dimension to obtain updated information corresponding to the dimension comprises:
normalizing the information corresponding to the dimension; and
compensating a normalization result according to the variation of the information corresponding to the dimension to obtain the updated information corresponding to the dimension.

19. The electronic device according to claim 17, wherein determining the variation of the driving feature according to the driving feature and the updated feature comprises:
determining a norm of a difference between the driving feature and the updated feature according to the driving feature and the updated feature;
for each of the at least one of the predetermined dimensions, determining a negative correlation function of the variation of the information corresponding to the dimension; and
determining the variation of the driving feature according to the norm and the negative correlation function of each of the at least one of the predetermined dimensions.

20. The electronic device according to claim 14, wherein according to the variation representative value of the information corresponding to each of the at least one of the predetermined dimensions, determining, from the information corresponding to each of the at least one of the predetermined dimensions, the driving risk factor corresponding to the risk value determined based on the driving feature comprises:
ranking the information corresponding to each of the at least one of the predetermined dimensions according to the variation representative value of the information corresponding to each of the at least one of the predetermined dimensions; and
determining, from the information corresponding to each of the at least one of the predetermined dimensions, the driving risk factor according to a ranking result.
